(19) United States
(12) Patent Application Publication
(10) Pub. No.: US 2013/0271395 A1
(43) Pub. Date: Oct. 17, 2013

(54) TOUCH DISPLAY DEVICE AND METHOD FOR CONDITIONALLY VARYING DISPLAY AREA

(71) Applicant: WISTRON CORPORATION, New Taipei City (TW)

(72) Inventors: Chu-Chia TSAI, New Taipei City (TW); Randy Lu Hung CHANG, New Taipei City (TW)

(73) Assignee: WISTRON CORPORATION, New Taipei City (TW)

(21) Appl. No.: 13/690,565

(22) Filed: Nov. 30, 2012

(30) Foreign Application Priority Data
Apr. 11, 2012 (TW) 101112881

(51) Int. Cl. G06F 3/041

(52) U.S. Cl. CPC G06F 3/041
USPC 345/173

(57) ABSTRACT

A touch display device includes a display panel, a touch panel, a trigger module and a control module. The touch panel has a sensing area equivalent to the maximum display area of the display panel. The sensing area detects a touch event occurring thereon in order to generate a touch instruction. The control module executes the touch instruction and generates a display signal to drive the display panel to display images in the current display area which is not greater than the maximum display area. When the trigger module generates a trigger signal, the control module reduces the current display area to form a blank region in at least one side of the current display area. Accordingly, the touch event occurring on the blank region generates an invalid touch instruction.

### CROSS-REFERENCES TO RELATED APPLICATIONS

This non-provisional application claims priority under 35 U.S.C. §119(a) on Patent Application No. 101112881 filed in Taiwan, R.O.C. on 2012/04/11, the entire contents of which are hereby incorporated by reference.

### BACKGROUND

1. Technical Field

The disclosure relates to touch operations of an electronic device, in particular to a touch display device and method for conditionally varying display area.

2. Related Art

Accompanying the development of information technology and the increase of internet coverage, touch display devices such as smartphones or tablet computers have become increasingly popular recently, and become significant interfaces for acquiring or exchanging information. This enables a user to freely browse multimedia information such as internet information or e-books, anytime and anywhere.

FIG. 1 illustrates a conventional touch display device 100. A touch screen 120 is installed in a housing 110 on the touch display device 100. The purpose of touch screen 120 displays an image and allows a user to touch on the touch screen 120 to operate the touch display device 100. The touch display device 100 includes a border 110a with a certain width (at least greater than the width of a human thumb), surrounding the peripheral of the touch screen 120. When the user holds the touch display device 100, their thumb or other portion of their hand is able to contact the border 110a. Thus, the border 110a prevents the user from interfering with the operation of the touch display device 100 when the user holds the touch display device 100 and touches the touch screen 120.

However, for the purpose of conveniently carrying the touch display device 100, the size of the touch display device 100 must be further reduced. Nevertheless, after reducing the size of the touch display device 100, the width of the border 110a must be reduced as well to avoid over-reducing the size of the touch screen 120. Accordingly, if the width of the border 110a is reduced, the way that the user holds the touch display device 100 must be changed to prevent from misoperations of the touch screen 120. Alternatively, the width of the border 110a may be maintained at a certain width; however, the size of the touch screen 120 becomes over-reduced without corresponding to the user's general need of a large display area.

In order to balance the needs of device downsizing and screen enlarging, U.S. Pat. No. 7,426,107 introduces a flexible display as the screen for an electronic device. Through the flexible display, both the needs of portability and browsability may be fulfilled. However, such a display has higher cost and is still difficult to produce using current technology.

### SUMMARY

In response to the technical problems described previously, the disclosure provides a touch display device and method of conditionally varying touch area. The problem existing in the prior art (failure to downsize a touch display device and maintain the maximum display area in the meantime), is resolved accordingly.

In one or more embodiments of the disclosure, a touch display device is provided to vary a display area thereof according to operating methods. The touch display device includes a display panel, a touch panel, a trigger module and a control module.

The display panel has a maximum display area. In the maximum display area, a current display area is defined not greater than the maximum display area. The display panel displays an image in the current display area.

The touch panel is combined on the display panel. The touch panel has a sensing area equivalent to the maximum display area of the display panel, so as to detect a touch event occurring on the sensing area and generate a touch instruction accordingly.

The trigger module generates a trigger signal. The control module generates a display signal to drive the display panel to display images in the current display area. The control module is also to receive and execute the touch instruction. When the trigger module generates the trigger signal, the control module reduces the current display area so it is smaller than the maximum display area, and forms a blank region in at least a side of the current display area, so that the touch event occurred on the blank region generates the touch instruction without a response.

Therefore, when a user holds the touch display device with their hand(s) contacting the blank region, the user's holding action is prevented from causing misoperations of the display panel.

In one or more embodiment, a method for conditionally varying a display area is adapted for a touch display device. The touch display device includes a display panel and a touch panel combined on the display panel. The display panel has a maximum display area, and the touch panel has a sensing area equivalent to the maximum display area.

The method includes: generating a display signal, to drive the display panel to display images in the current display area; generating and executing a touch instruction according to a touch event occurring on the sensing area, wherein the touch instruction including the touch event and a touch position; and determining whether a trigger signal is received; when the trigger signal is received, accordingly reducing the current display area to be smaller than the maximum display area, and forming a blank region in at least a side of the current display area, so that the touch event occurred on the blank region generates an invalid touch instruction.

According to the touch display device and method for conditionally varying a display area thereof, a touch display device is able to adopt reduced-border designs, without being concerned with a user's holding operation to widen the border, thereby making the touch display device lighter and easier to use. Based on reduced-border designs, a touch display may have a display area broader than the conventional ones to enhance the user's reading experience.

### BRIEF DESCRIPTION OF THE DRAWINGS

The disclosure will become more fully understood from the detailed description given herein below for illustration only and thus not limitative of the present invention, wherein:

FIG. 1 is a front view of a touch display device in the prior art;

FIG. 2 is a front view of a touch display device according to a first embodiment;

FIG. 3 is a circuit block diagram of the touch display device according to the first embodiment;

FIG. 4 is an explosive view of a display panel and a touch panel according to the first embodiment;

FIGS. 5, 6 and 7 are front views of the touch display device according to the first embodiment, illustrating the changes of a current display area;

FIG. 8 is a rear view of a touch display device according to a second embodiment;

FIG. 9 is a front view of a touch display device according to a third embodiment;

FIG. 10 is a circuit block diagram of the touch display device according to the third embodiment;

FIG. 11 is a flow chart of a method for conditionally varying display area according to another embodiment;

FIG. 12 is a flow chart I of reducing a current display area according to another embodiment; and

FIG. 13 is a flow chart II of reducing a current display area according to another embodiment.

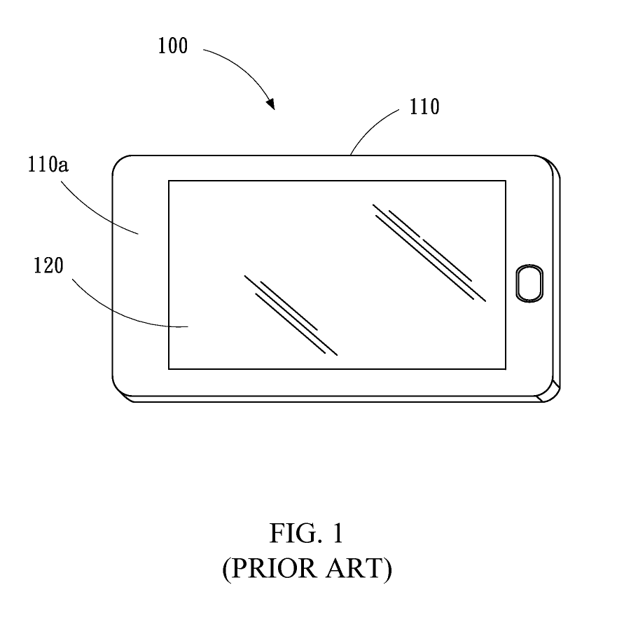

### DETAILED DESCRIPTION

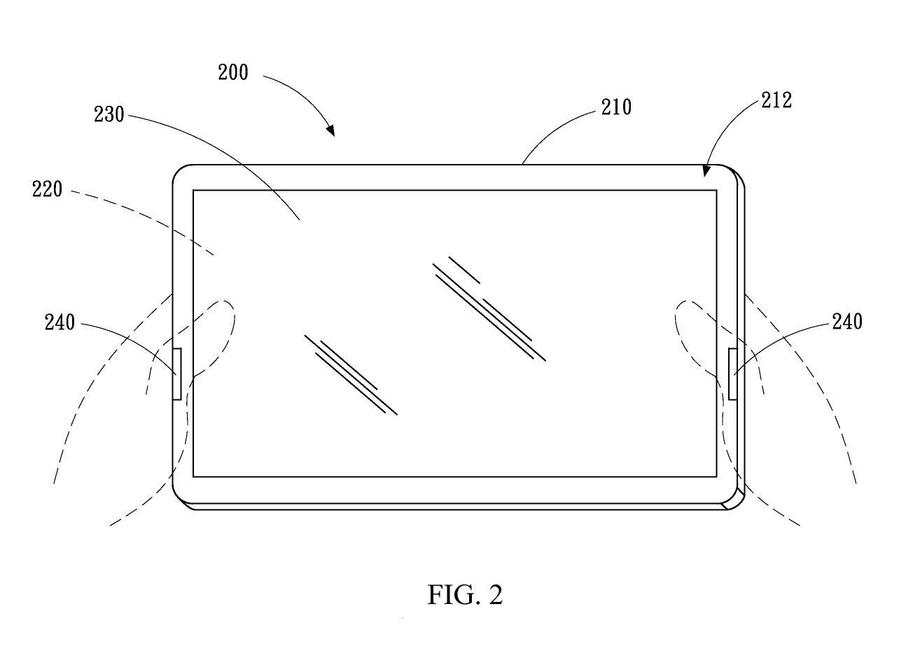

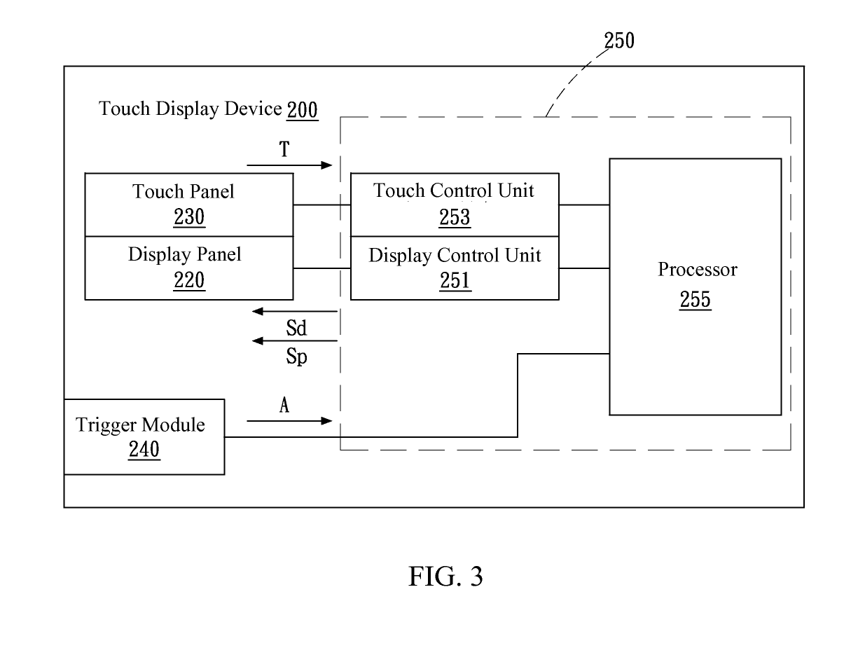

Please refer to FIG. 2 and FIG. 3, in which a touch display device 200 according to a first embodiment is disclosed to vary a sensing area based on user's operation methods, and further to adjust a display area. A practical example for the touch display device 200 is tablet computer, without excluding any other type of the touch display device 200.

As shown in FIGS. 2, 3 and 4, the touch display device 200 includes a housing 210, a display panel 220, a touch panel 230, a trigger module 240 and a control module 250.

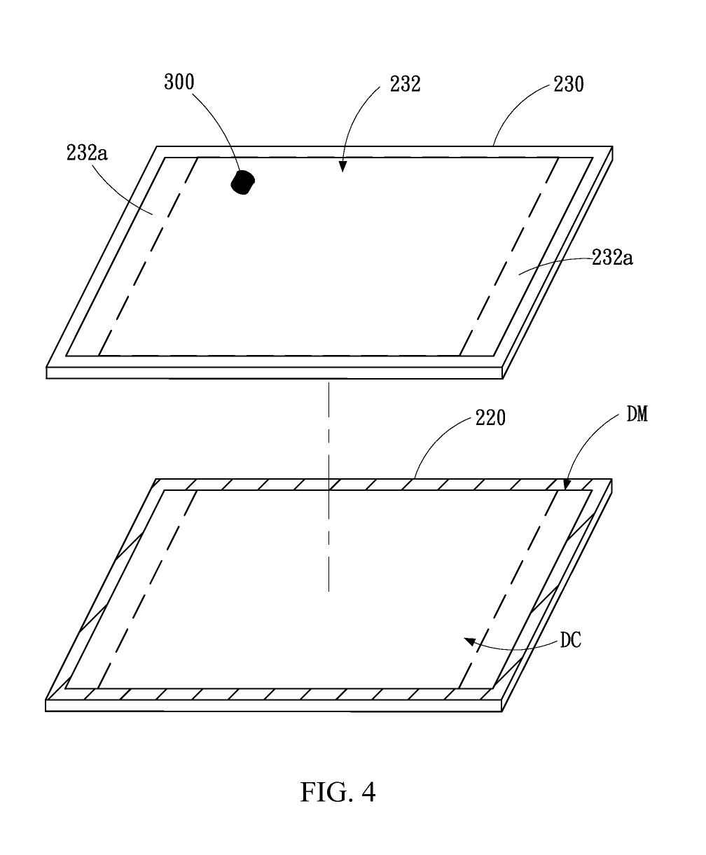

As shown in FIGS. 2 and 4, the housing 210 has a border 212. The display panel 220 and the touch panel 230 are installed within the border 212 of the housing 210. The touch panel 230 is combined on the display panel 220, which may be possibly realized by attaching the touch panel 230 onto the display panel 220, or embedding touch control components inside the display panel 220 to form an in-cell touch panel or an embedded optical touch panel. The trigger module 240 is disposed on the border 212 of the housing 210, at an edge of the border 212.

As shown in FIG. 4, the display panel 220 has a maximum display area DM; in the maximum display area DM, a current display area DC is defined not greater than the maximum display area DM. The display panel 220 displays an image in the current display area DC. When the display panel 220 display the image in a full-screen mode, the current display area DC is equivalent to the maximum display area DM. When the display panel 220 displays the image in a partial display mode, the current display area DC is smaller than the maximum display area DM, and located inside the maximum display area DM. The area difference is shown at one or more sides thereof, preferably shown symmetrically at the left and right sides of the current display area DC with the same predetermined width or a user-adjustable width, namely a so-called “Letter box”; the letter box is defined as a blank region 232a.

As shown in FIGS. 2, 3 and 4, the touch panel 230 may be realized by resistive type, surface capacitive type, projected capacitive type, infrared type, optical image type, surface wave type or electromagnetic type sensing technologies, in order to sense touch events. The touch panel 230 is installed in the border 212 of the housing 210 and combined on the display panel 220. The touch panel 230 has a sensing area 232 equivalent to the maximum display area DM; the sensing area 232 is able to be equivalent to the maximum display area DM (including slightly smaller or greater than the range of the maximum display area DM). The touch panel 230 detects the touch event with an object 300 contacts on the sensing area 232, to generate a touch instruction T; wherein the touch instruction T includes the touch event and a touch position.

As shown in FIGS. 2 and 3, the trigger module 240 is disposed on the front side of the border 212 of the housing 210. The trigger module 240 detects if a user's hand is placed on the border 212, and to generate a trigger signal A when detecting a hand (usually the thumb), placed on the border 212. In a practical example, the trigger module 240 is an optical detecting element; when the user's hand is placed on the border 212 and on the trigger module 240, the external lights projected onto the trigger module 240 is blocked by the hand, so that the trigger module 240 generates the trigger signal A. In another practical example, the trigger module 240 is a combination of two metal conductors disposed on the border 212; when the user's hand is placed on the border 212 and contacts the two metal conductors at the same time, the two metal conductors are short-circuited, causing the trigger module 240 to generate the trigger signal A. In another practical example, the trigger module 240 is a button switch for the user to switch and thereby generating the trigger signal A; in this application, the trigger module 240 does not need to actively detect if the user's hand is placed on the border 212.

As shown in FIGS. 3 and 4, the control module 250 is installed in the housing 210, and the display panel 220, the touch panel 230 and the trigger module 240 electrically connect with the control module 250. The control module 250 generates a display signal Sd to drive the display panel 220 to display images in the current display area DC. The control module 250 also receives the touch instruction T generated by the touch panel 230, and further executes the touch instruction T.

As shown in FIGS. 3 and 4, when the control module 250 receives the trigger signal A, the control module 250 adjusts the display signal Sd into a partial display signal Sp, so as to reduce the range of the current display area DC, thereby driving the display panel 220 to display the same image with only a portion of the maximum display area DM. Namely, the area of the displayed image is reduced, so that blank regions 232a are formed at the two sides of the displayed image.

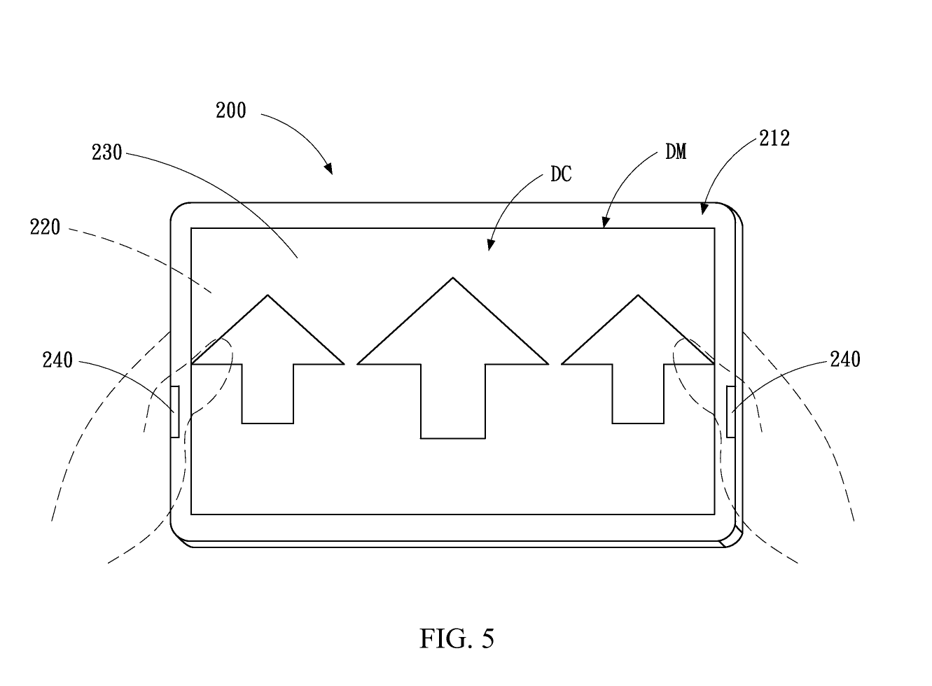

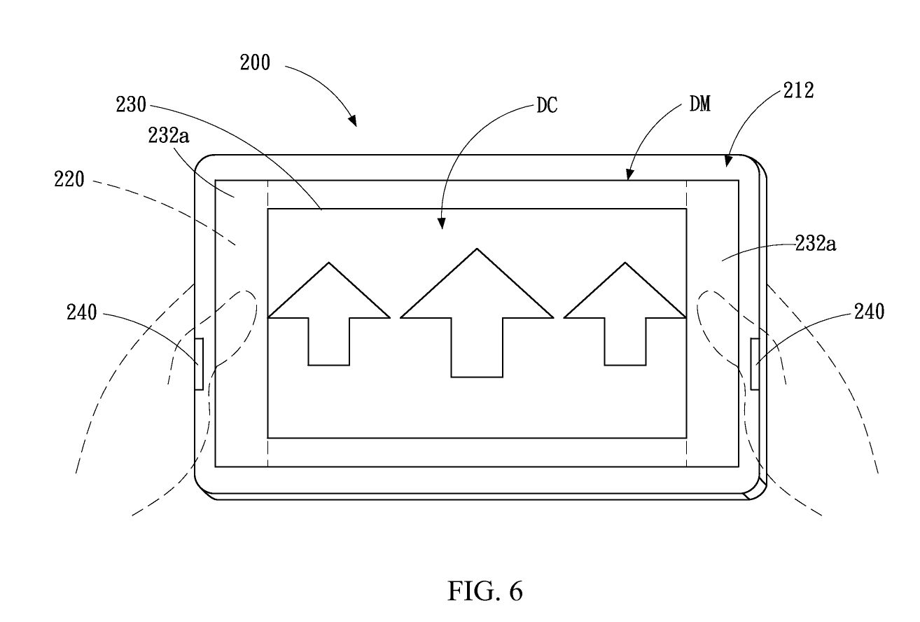

As shown in FIGS. 5 and 6, one of the methods of reducing the current display area DC is that the control module 250 reduces the height and width of the current display area DC at a same proportion, adjusts the display resolution corresponding to the display signal Sd and generates a partial display signal Sp to adjust the image proportion or the display proportion, and makes the partial display signal Sp corresponding to the reduced current display area DC. For example, the original current display area DC equivalent to the maximum display area DM has a 10.1 inches diagonal and a 16:9 display area. When the current display area DC is reduced, the reduced current display area DC might become 7 inches diagonal with 16:9 display area, so that at one or two sides of the reduced current display area DC, the blank region(s) 232a without displaying any image is formed for hand held use.

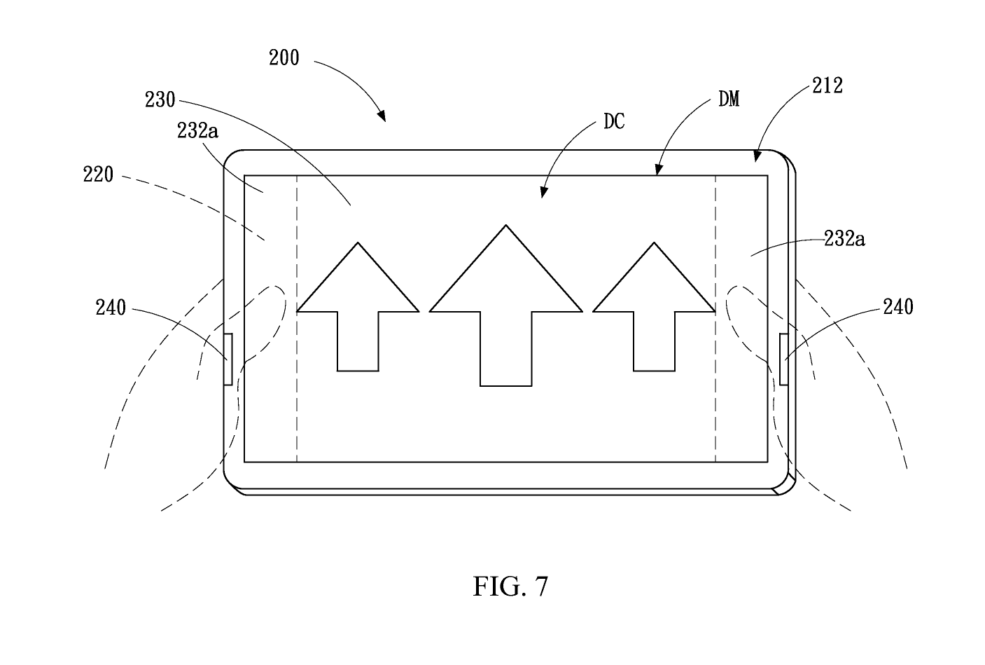

As shown in FIGS. 5 and 7, another method of reducing the current display area DC is that, along a vertical axis at one side of the current display area DC, the control module 250 reduces the current display area DC inwardly; and afterwards the control module 250 changes the height-width proportion and the display resolution corresponding to the display signal Sd, so as to generate the partial display signal Sp corresponding to the reduced current display area DC.

For example, the original current display area DC equivalent to the maximum display area DM has a 10.1 inches diagonal and a 16:9 display area. When the current display area DC is reduced, the current display area DC becomes the same height with the height-width proportion changed into 4:3, so that at one or two sides of the reduced current display area DC, the blank region(s) 232a without displaying any image is formed for hand held use.

As shown in FIG. 3, in a practical embodiment, the control module 250 includes a display control unit 251, a touch control unit 253 and a processor 255. The display control unit 251 and the touch control unit 253 are able to be realized by a single chip respectively, or by integrating with the processor 255 into an integrated chip. The display control unit 251 and the touch control unit 253 may possibly be realized by software functional modules, which may be operated by program code executing through the processor 255.

As shown in FIG. 3, the display control unit 25 may be realized by a display driver chip. The display control unit 25 is electrically connected with the display panel 220, so as to output the display signal Sd to the display panel 220, and to adjust the display signal Sd as a full-screen display signal Sd or the partial display signal Sp based on commands of the processor 255, thereby reducing or expanding the current display area. A practical example for the touch control unit 253 is a touch-control decoding chip. The touch control unit 253 is electrically connected with the touch panel 230, so as to receive the touch instruction T sent by the touch panel 230, decode the touch instruction T and determine the touch position corresponding to the touch instruction T.

As shown in FIGS. 5, 6 and 7, in other words, in the first embodiment, the default display mode of the touch display device 200 is to adopt the entire maximum display area DM as the current display area DC to display images. When the user's hand is holding on the border 212 of the housing 210 and possibly contacting the blank region 232a at a side of the display panel 220, through the sensing function of the trigger module 240, the control module 250 reduces the displayed range of the current display area DC. Accordingly, the image display range of the touch display device 200 is reduced, and at one or two sides of the reduced current display area DC, the blank region(s) 232a without displaying any image is formed for hand held use. Therefore, even if the user's hand (usually the thumb), is contacting and pressing on the blank region 232, the touch instruction T generated by the touch panel 230 becomes invalid input without any responses, and the hand does not block the display images. In another practical example, when the control module 250 receives the trigger signal A, the control module 250 not only reduces the current display area DC to form the blank regions 232a at the two sides thereof, but also disable the portion of the sensing area 232 of the touch panel 230 corresponding to blank region 232a, thereby causing the portion to lose touch-sensing capability and further ensuring no touch response is generated when the finger(s) holds or contacts the blank region 232a.

When the trigger module 240 stops outputting the trigger signal A, or after a predetermined period without generating the trigger signal A, or the trigger signal A is deactivated, for example the user's hand moving away from the border 212 or no longer contact or block the trigger module 240, or the user manually switching trigger module 240, the control module 250 adjusts the display signal Sd as the full-screen display signal Sd, so that when the display panel 220 receives the full-screen display signal Sd, the current display area DC is recovered and expanded to correspond with the entire range of the maximum display area DM, and the entire maximum display area DM is used to display the image.

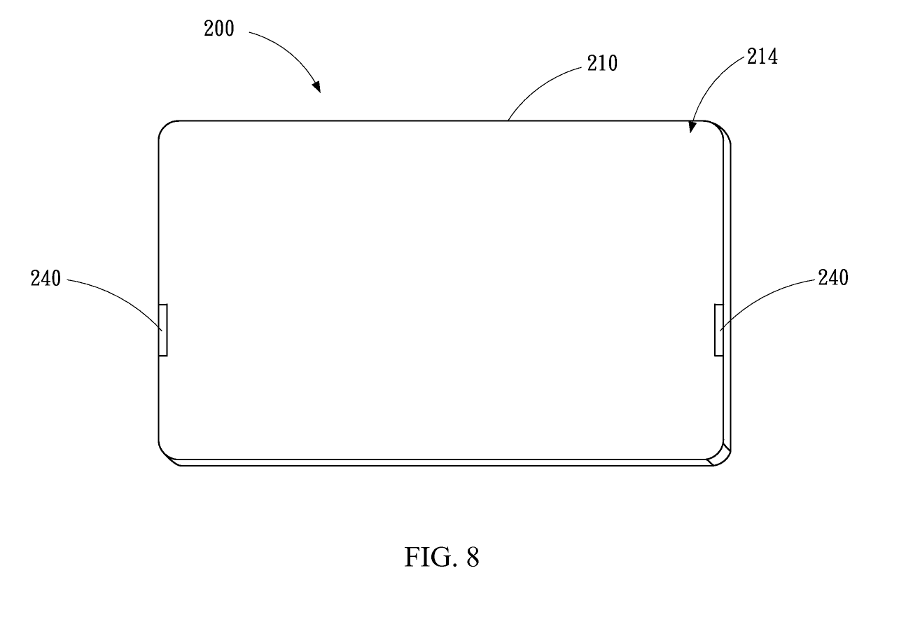

Please refer to FIG. 8, which discloses a touch display device 200 according to a second embodiment. The housing 210 further includes a rear surface 214 corresponding to the border 212. The touch display device 200 in the second embodiment is similar to the one in the first embodiment, the difference is that, the trigger module 240 is disposed at the rear surface 214 of the housing 210 with the trigger module 240 being disposed close to an edge of the rear surface 214 of the housing 210. The trigger module 240 detects if a user's hand is holding the housing 210 and to generate the trigger signal A when a portion of the hand (such as the four fingers other than the thumb), is placed on the rear surface 214. A practical example of the trigger module 240 includes an optical detecting element, a combination of two metal conductors, a button switch, etc.

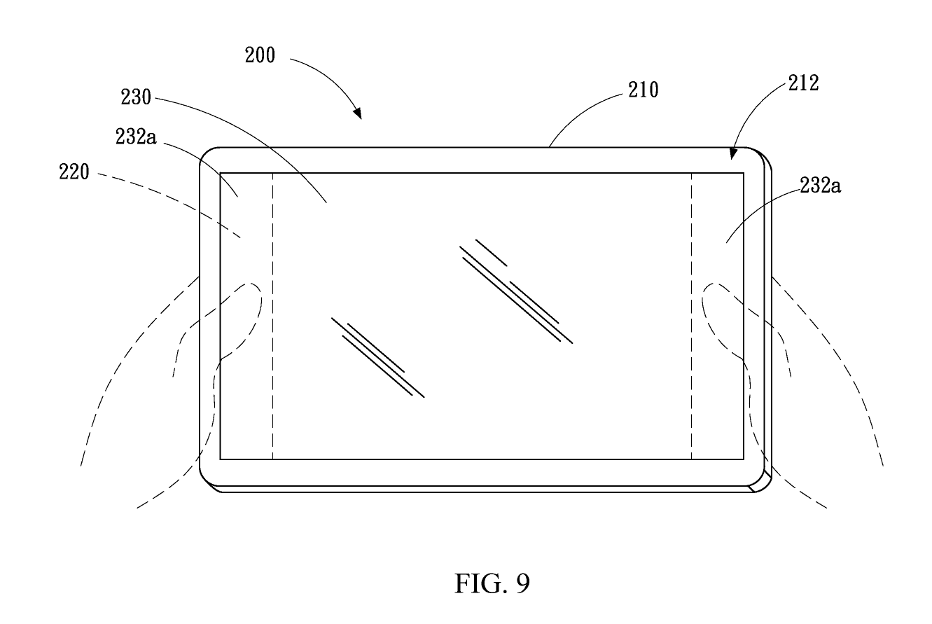

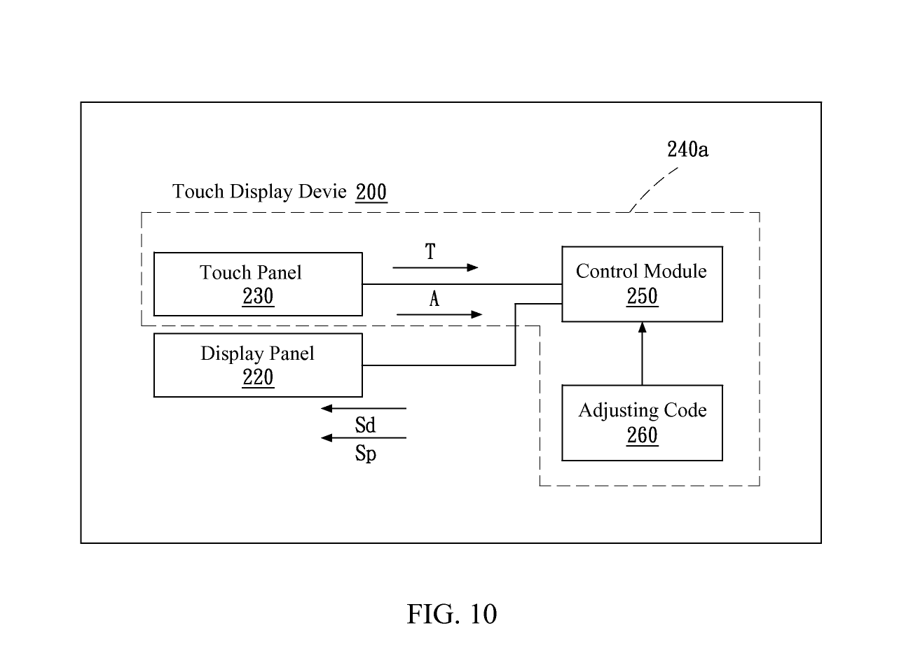

Please refer to FIGS. 9 and 10, which disclose a touch display device 200 according to a third embodiment. The touch display device 200 includes a housing 210, a display panel 220, a touch panel 230, a trigger module 240a, and a control module 250.

As shown in FIG. 10, the trigger module 240a is a functional module including the touch panel 230, the control module 250 and an adjusting code 260. When the touch display device 200 is boosted, the control module 250 loads the adjusting code 260 from a storage unit and executes. Next, the control module 250 receives the touch instruction T output by the touch panel 230 and determines the touch position corresponding to the touch instruction T. When the object 300 (e.g. the user's hand), contacts the touch panel 230, the touch position corresponding to the touch instruction T generated by the touch panel 230 is located in a designated block. The designated block is for example a specific partial position in the blank region, or corresponds to a displayed software button icon in the reduced current display area or in the blank region. The control module 250 defines the touch instruction T occurring on the designated block as the trigger signal A. Namely, unlike generating the trigger signal A through the hardware or mechanical means in the above embodiments, here the trigger signal A is generated through software means. Similar to the embodiments mentioned previously, when the control module 250 receives the trigger signal A, the control module 250 outputs the partial display signal Sp to reduce the current display area DC.

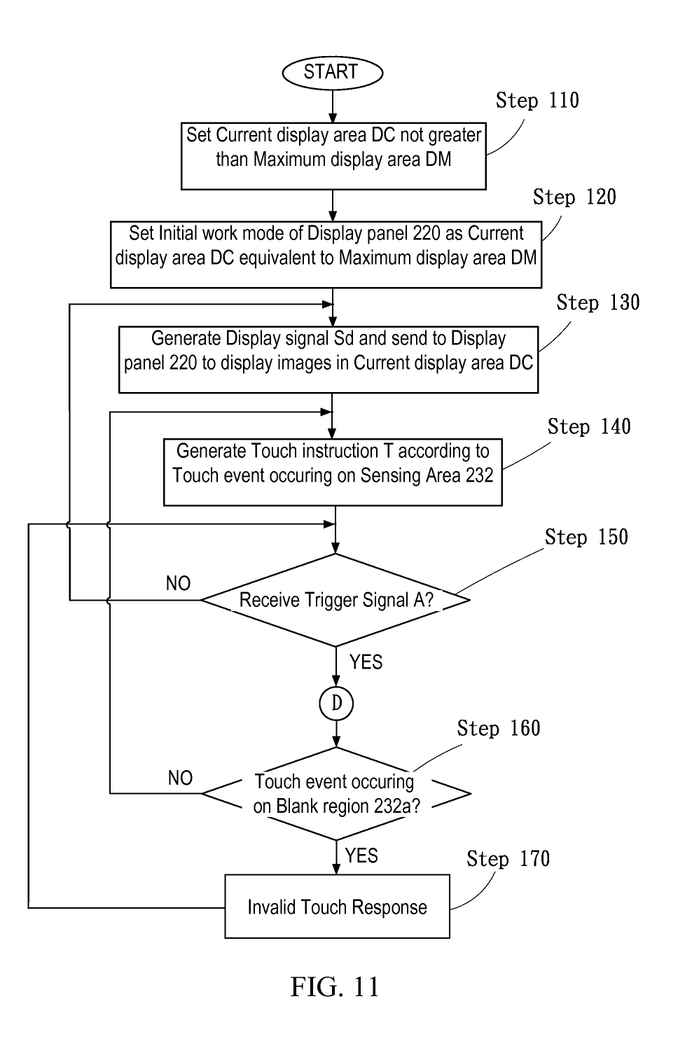

As shown in FIG. 11, a method for conditionally varying display area, adapted for a touch display device 200, is disclosed according to another embodiment of the disclosure. The method for conditionally varying a display area of the touch display device 200 is described as follows.

After the touch display device 200 is boosted, the touch display device 200 firstly processes with initializing operation. During the initializing operation, the control module 250 defines a current display area DC in the maximum display area DM of the display panel 220; the current display area DC is defined not greater than the maximum display area DM and an image is displayed in the current display area DC, as shown in Step 110.

The control module 250 sets an initial work mode of the display panel 220 as the current display area DC equivalent to the maximum display area DM; namely displaying the image with the maximum display area DM of the display panel 220, as shown in Step 120.

The control module 250 generates a display signal Sd and sends to the display panel 220, so as to display the image in the current display area DC of the display panel 220, as shown in Step 130. At this moment the current display area DC is equivalent to the maximum display area DM, so the display panel 220 display images with the maximum display area DM.

Subsequently, if a user's hand or other object 300 operates on the sensing area 232 of the touch panel 230, a touch event is generated. The touch panel 230 generates a touch instruction T according to the touch event occurring on the sensing area 232, as shown in Step 140; wherein the touch instruction T includes the touch event and a touch position.

The control module 250 determines whether to execute the touch instruction T according to operating conditions. The determining process executed by the control module 250 is described as follows.

The control module 250 determines if a trigger signal A is received, as shown in Step 150. The trigger signal A is generated by the trigger module 240; a practical example of the trigger module 240 includes an optical detecting element, a combination of two metal conductors or a button switch.

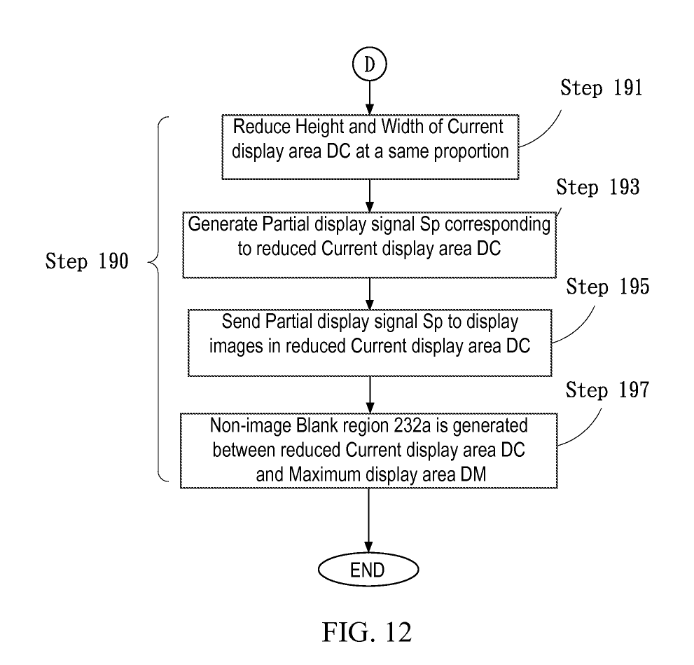

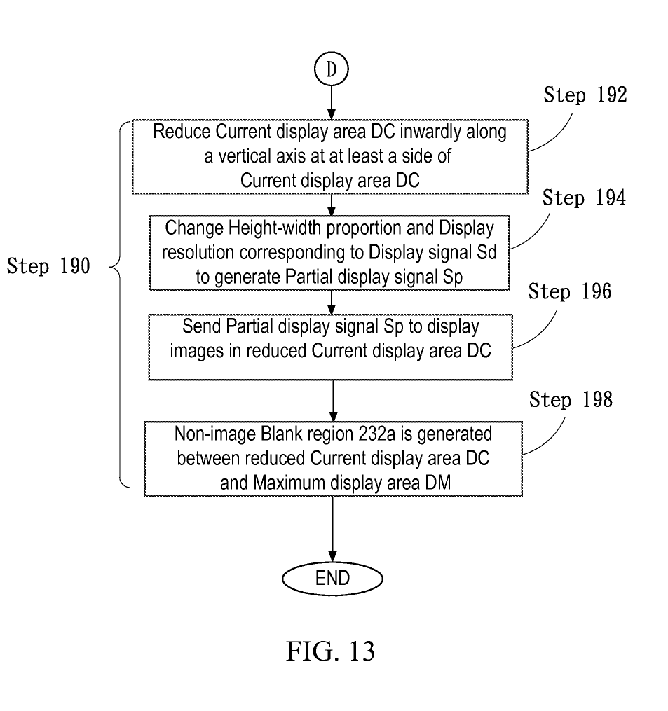

When receiving the trigger signal A, as shown in FIGS. 12 and 13, the control module 250 adjust the display signal Sd into a partial display signal Sp, so as to reduce the current display area DC and the displayed image, as shown in Step 190.

As shown in FIG. 12, the step of reducing the current display area DC to reduce the displayed image includes the following process. The control module 250 reduces the height and width of the current display area DC at a same proportion, as shown in Step 191. Next, the control module 250 adjusts the display resolution corresponding to the display signal Sd to generate a partial display signal Sp corresponding to the reduced current display area DC, as shown in Step 193. Finally, the control module 250 sends the partial display signal Sp to the display panel 220, so that the display panel 220 displays the image with the reduced current display area DC, as shown in Step 195; sequentially, the non-image blank region(s) 232a is generated between the reduced current display area DC and the maximum display area DM, as shown in Step 197.

As shown in FIG. 13, in anther embodiment, the step of reducing the current display area DC to reduce the displayed image includes the following process. The control module 250, along a vertical axis in at least a side or at the opposite two sides of the current display area DC, reduces the current display area DC inwardly, as shown in Step 192. The control module 250 changes the height-width proportion and display resolution corresponding to the display signal Sd, so as to generate the partial display signal Sp corresponding to the reduced current display area DC, as shown in Step 194. Finally, the control module 250 sends the partial display signal Sp to the display panel 220, so that the display panel 220 displays the image with the reduced current display area DC, as shown in Step 196; afterwards, the non-image blank region(s) 232a is generated between the reduced current display area DC and the maximum display area DM, as shown in Step 198.

Please refer again to FIG. 11, in which after the display panel 220 displays the image with the reduced current display area DC and generates the blank region 232a at the side(s) thereof, detect if a touch event is occurring on the blank region 232a, as shown in Step 160. If the touch event is determined to be occurring on the blank region 232a, since no image is displayed in the blank region 232a, the touch panel 230 is still operated to generate the touch instruction T. However, the touch instruction T becomes an invalid touch input and no touch response is generated on the displayed image, as shown in Step 170. Subsequently, return to Step 150 to detect continuously if the trigger signal A still exists or is already deactivated.

In Step 150 mentioned previously, if the trigger signal A is not received, return to Step 130 to keep displaying images with the maximum display area DM. Additionally, if in Step 160 the touch event does not occur on the blank region 232a, return to Step 140 to generate normally the touch instruction T to operate the displayed images.

In short, based on the disclosed touch display device 200 and method for conditionally varying display area, the touch display device 200 is able to adopt reduced-border or even non-border designs, without being concerned with the user's holding operation to widen the border. With narrow border designs, the touch panel is able to have a display area broader than the conventional ones to enhance the benefit for user reading. In addition, when the touch display device 200 is held, through the technology means disclosed in the embodiments, an enlarged-border effect may be provided to prevent the user from misoperations of the touch operating interface. Furthermore, the touch display device 200 is able to change the displayed image size and height-width proportion, so that the displayed image is not blocked by the user's hand.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A touch display device, varying a display area thereof according to operating manners, comprising:
a display panel, having a maximum display area in which a current display area is defined no greater than the maximum display area, the display panel displaying images in the current display area;
a touch panel, combined on the display panel, the touch panel having a sensing area equivalent to the maximum display area of the display panel, so as to detect a touch event occurring on the sensing area and generate a touch instruction accordingly;
a trigger module, generating a trigger signal; and
a control module, generating a display signal to drive the display panel to display images in the current display area, the control module receiving and executing the touch instruction;
wherein when the trigger module generates the trigger signal, the control module reduces the current display area to be smaller than the maximum display area and form a blank region in at least a side of the current display area, so that the touch event occurred on the blank region generates an invalid touch instruction.

2. The touch display device according to claim 1 further comprising a housing, the housing comprising a border with the display panel and the touch panel being disposed therein.

3. The touch display device according to claim 2, wherein the trigger module is installed on the border of the housing.

4. The touch display device according to claim 2, wherein the housing further comprises a rear surface with the trigger module being disposed close to an edge of the rear surface of the housing.

5. The touch display device according to claim 1, wherein the trigger module is an optical detecting element, a combination of two metal conductors or a button switch.

6. The touch display device according to claim 1, wherein when the control module receives the trigger signal, the control module adjusts the display signal into a partial display signal, so as to drive the display panel to display images in the adjusted current display area formed by a portion of the maximum display area.

7. The touch display device according to claim 6, wherein the control module comprises:
a processor;
a display control unit, electrically connecting with the display panel to output the display signal to the display panel, and to adjust the display signal into the partial display signal according to commands of the processor; and
a touch control unit, electrically connection with the touch panel to receive the touch instruction sent from the touch panel, and to decode the touch instruction and determine a touch position corresponding to the touch instruction.

8. The touch display device according to claim 6, wherein the control module reduces the current display area under a same height-width proportion, and adjusts a display resolution corresponding to the display signal to generate the partial display signal.

9. The touch display device according to claim 6, wherein the control module changes a height-width proportion and a display resolution to generate the partial display signal corresponding to the display signal.

10. The touch display device according to claim 1, wherein the trigger module comprises the touch panel, the control module and an adjusting code, the control module loading and executing the adjusting code, and the control module receiving the touch instruction to determine the touch position corresponding to the touch instruction; when the touch position corresponding to the touch instruction is located in a designated block, the control module defines the touch instruction located in the designated block as the trigger signal.

11. The touch display device according to claim 10, wherein the designated block is a specific partial position in the blank region, or corresponds to a displayed software button icon in the reduced current display area or in the blank region.

12. The touch display device according to claim 1, wherein the blank region is a difference range between the maximum display area and the reduced current display area, and the blank region is formed at least at left and right sides of the current display area without displaying images.

13. The touch display device according to claim 1, wherein when the control module receives the trigger signal, the sensing area of the touch panel corresponding to the blank region is disabled to be incapable of inputting the touch instruction.

14. A method for conditionally varying display area, adapted for a touch display device, wherein the touch display device comprised a display panel and a touch panel combined on the display panel, the display panel having a maximum display area in which a current display area is defined no greater than the maximum display area, the touch panel having a sensing area equivalent to the maximum display area, the method comprising:
generating a display signal to drive the display panel to display images in the current display area;
generating and executing a touch instruction according to a touch event occurring on the sensing area, wherein the touch instruction comprising the touch event and a touch position; and
determining whether a trigger signal is received; when the trigger signal is received, accordingly reducing the current display area to be smaller than the maximum display area, and forming a blank region in at least a side of the current display area, so that the touch event occurring on the blank region generates an invalid touch instruction.

15. The method according to claim 14, wherein the trigger signal is generated by a trigger module.

16. The method according to claim 15, wherein the touch display device further comprises a housing, the housing having a border with the display panel and the touch panel being disposed therein, and the trigger module being installed on the border of the housing.

17. The method according to claim 15, wherein the touch display device further comprise a housing with a rear surface, the trigger module being disposed close to an edge of the rear surface of the housing.

18. The method according to claim 14 further comprising:
wherein the trigger signal is received, adjusting the display signal into a partial display signal, so as to drive the display panel to display images in the adjusted current display area formed by a portion of the maximum display area.

19. The method according to claim 14, wherein the step of reducing the current display area comprises:
reducing the height and width of the current display area under a same proportion; and
adjusting the display resolution corresponding to the display signal and generating a partial display signal corresponding to the reduced current display area.

20. The method according to claim 14, wherein the step of reducing the current display area comprises:
reducing the current display area inwardly along a vertical axis at a side of the current display area; and
changing a height-width proportion and a display resolution corresponding to the display signal to generate a partial display signal corresponding to the reduced current display area.

21. The method according to claim 14, wherein the trigger signal is the touch instruction generated in a designated block of the display panel.

22. The method according to claim 21, wherein the designated block is a specific partial position in the blank region, or corresponds to a displayed software button icon in the reduced current display area or in the blank region.

23. The method according to claim 14, wherein the blank region the blank region is a difference range between the maximum display area and the reduced current display area, and the blank region is formed at least at left and right sides of the current display area without displaying images.

24. The method according to claim 14, wherein when the trigger signal is received, the sensing area of the touch panel corresponding to the blank region is disabled to be incapable of inputting the touch instruction.
